(19) United States
(12) Patent Application Publication
(10) Pub. No.: US 2010/0262460 A1
(43) Pub. Date: Oct. 14, 2010

(54) Operating An Electronic Advertising Device

(75) Inventors: Nicholas W. Brown, Cary, NC (US); Robert S. Hoblit, Raleigh, NC (US); Thomas J. Prorock, Raleigh, NC (US); Karen Waluk, Raleigh, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/423,282

(22) Filed: Apr. 14, 2009

(51) Int. Cl. G06Q 30/00; G06Q 99/00; H04N 5/225

(52) U.S. Cl. 705/10; 348/373; 348/E05.024; 705/14.66; 705/14.58

(57) ABSTRACT

Operating an electronic advertising device, the electronic advertising device disposed within camera range of consumer products exhibited for sale, the electronic advertising device including a computer processor, computer memory, a display, and a digital camera; the camera characterized by a camera range; the electronic advertising device operatively coupled to data storage containing digital reference images of at least some of the consumer products exhibited for sale, data storage containing rules for displaying advertising content for the consumer products exhibited for sale, and data storage containing the advertising content for the consumer products exhibited for sale; including: identifying, by the electronic advertising device through the camera and the digital reference images, consumer products within camera range of the electronic advertising device; and displaying, by the electronic advertising device in accordance with the rules, advertising content for the identified consumer products.

### BACKGROUND OF THE INVENTION

1. Field of the Invention

The field of the invention is data processing, or, more specifically, methods, apparatus, and products for operating an electronic advertising device.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Many retailers are deploying electronic advertising displays that are mounted at various fixed strategic locations throughout the store. It is also conceivable that in the future there will be mobile versions of these electronic displays that can be easily moved to various locations throughout the store. There is much time, labor, and programming that is involved in the rolling out an advertising promotion to be deployed on the electronic displays. Disclosed is a novel system for self configuring advertising displays that reduce the complexity, labor, and programming that is involved in the deployment of advertising campaigns to electronic displays.

### SUMMARY OF THE INVENTION

Methods, apparatus, and computer program products are disclosed for operating an electronic advertising device, the electronic advertising device disposed within camera range of consumer products exhibited for sale, the electronic advertising device including at least one computer processor, computer memory, a display, and a digital camera, the processor operatively coupled to the memory, the display, and the camera; the camera characterized by the camera range, the camera range being a distance from the camera within which the camera can effectively capture digital images of consumer products exhibited for sale; the electronic advertising device operatively coupled to data storage containing digital reference images of at least some of the consumer products exhibited for sale; the electronic advertising device also operatively coupled to data storage containing rules for displaying advertising content for the consumer products exhibited for sale, each rule associating a consumer product with advertising content for that same consumer product; the electronic advertising device also operatively coupled to data storage containing the advertising content for the consumer products exhibited for sale; including identifying, by the electronic advertising device through the camera and the digital reference images, consumer products within camera range of the electronic advertising device; and displaying, by the electronic advertising device in accordance with the rules, advertising content for the identified consumer products.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a line drawing of an example electronic advertising device according to embodiments of the present invention.

FIG. 2 sets forth a block diagram of automated computing machinery useful in operating an electronic advertising device according to embodiments of the present invention.

FIG. 3 sets forth an entity relationship diagram of several example data structures useful in operating an electronic advertising device according to embodiments of the present invention.

FIG. 4 sets forth a flow chart illustrating an example method of operating an electronic advertising device according to embodiments of the present invention.

FIG. 5 sets forth a flow chart illustrating an example method of operating an electronic advertising device according to embodiments of the present invention.

FIG. 6 sets forth a flow chart illustrating an example method of operating an electronic advertising device according to embodiments of the present invention.

FIG. 7 sets forth a flow chart illustrating an example method of operating an electronic advertising device according to embodiments of the present invention.

### DETAILED DESCRIPTION OF EXEMPLARY EMBODIMENTS

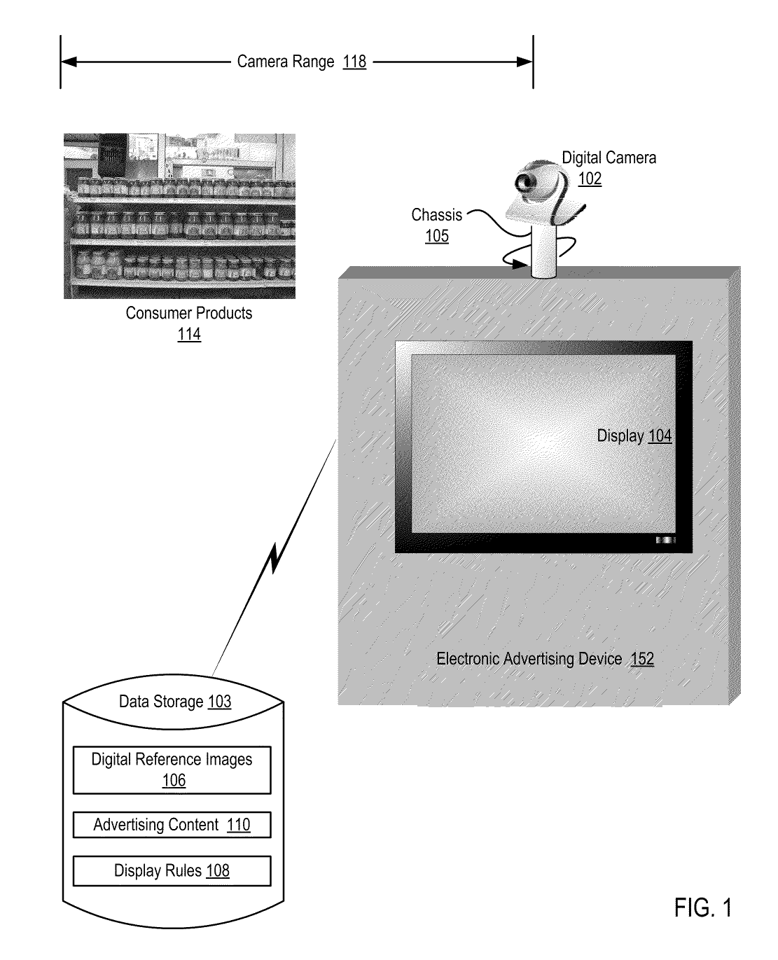

Example methods, apparatus, and products for operating an electronic advertising device in accordance with the present invention are described with reference to the accompanying drawings, beginning with FIG. 1. FIG. 1 sets forth a line drawing illustrating of an example electronic advertising device (152) according to embodiments of the present invention. The electronic advertising device (152) of FIG. 1 includes at least one computer processor, computer memory, a display (104), and a digital camera (102). In the example of FIG. 1, the processor is operatively coupled to the memory, the display (104), and the camera (102).

In the example of FIG. 1, the camera (102) is characterized by a camera range (118). A camera range is the distance from the camera within which the camera can effectively capture digital images of consumer products exhibited for sale. A digital image is effectively captured in the sense that the digital image is free of defects and the contents of the digital image can be identified. The camera range (118) of the digital camera (102) will vary in dependence upon features of the digital camera itself, as well as environmental conditions in which the camera operates. Features of the digital camera that will influence the camera range include, for example, the pixel count of a digital camera, the size of an image sensor within a camera, the quality of a camera's lens, and the organization of the pixels. Environmental conditions that impact the camera range include the quality of the lighting within a store, the presence of physical obstructions, and so on.

In the example of FIG. 1, the electronic advertising device (152) is operatively coupled to data storage (103) containing digital reference images (106) of at least some of the consumer products exhibited for sale. Digital reference images (106) are digital images of known consumer products. Such consumer products are known in the sense that each digital reference image has a unique product identifier associated with the image. Associating digital reference images with consumer product identifiers is carried out, for example, by use of a reference image table as illustrated in Table 1:

TABLE 1
Reference Image Table

| | Consumer | Consumer | |
|---|---|---|---|
| Reference | Product | Product | Advertising |
| Image | Identifier | Description | Content |
| //images/img1.jpg | 0001 | Chips | //ads/ad1.wmv |
| //images/img2.jpg | 0002 | Bean Dip | //ads/ad2.jpg |
| //images/img3.jpg | 0003 | Cheese Dip | //ads/ad3.wmv |
| //images/img4.jpg | 0004 | Cashews | //ads/ad4.wmv |
| //images/img5.jpg | 0005 | Peanuts | //ads/ad5.jpg |

Each record in table 1 represents an association between a digital reference image and an identifier for a consumer product. In the example of Table 1, each record also associates a digital reference image and an identifier of a consumer product with a consumer product description. Those of skill in the art will recognize that records in a reference image table, in addition to the fields shown in Table 1, can also include any information useful in identifying consumer products as will occur to those of skill in the art. In addition, the table structure is used in this example only for clarity of explanation, not as a limitation of the underlying invention. Readers will recognize that reference image records may be implemented with a variety of data structures and storage arrangements as will occur to those of skill in the art, including, for example, databases, linked lists, multi-dimensional arrays, and so on, and the use of all such data structures and storage arrangements for associating digital reference images with identifiers of consumer products is well within the scope of the present invention.

In the example of FIG. 1, the electronic advertising device (152) is also operatively coupled to data storage (103) containing rules (108) for displaying advertising content for the consumer products exhibited for sale. In the example of FIG. 1, each rule includes at least one association of a consumer product with advertising content for that same consumer product. The rules (108) are embodied as predefined logic that identifies particular advertising content that will be displayed in response to determining that a particular consumer product is within camera range of the electronic advertising device. An example of a simple rule is a rule that displays advertising content for each identified product that is within camera range of the electronic advertising device for a predetermined period of time. Rules may be more complex, for example, by displaying advertising content for more expensive products more frequently, by displaying advertising content for overstocked products more frequently, by displaying advertising content based upon the appearance of a consumer, and so on as will occur to those of skill in the art. The rules of example 1 are embodied as computer program instructions that, when executed, cause advertising content for the consumer products exhibited for sale to be displayed by the electronic advertising device.

In the example of FIG. 1, the electronic advertising device (152) is also operatively coupled to data storage (103) containing the advertising content (110) for the consumer products exhibited for sale. Advertising content (110) is embodied, for example, as images of a consumer product, audio commercials created for a consumer product, video commercials created for a consumer product, and so on. Data storage containing such advertising content is embodied, for example, as local storage such as a hard disk that resides within the electronic advertising display, as remote storage such as a server, or in any other way as will occur to those of skill in the art.

In the example of FIG. 1, the digital reference images (106), display rules (108), and advertising contents (110) are depicted as being stored in data storage (103) of a remote storage device. Applicants note that such a depiction is included only for the purpose of illustration and not as a limitation of the present invention. Digital reference images, display rules, and advertising contents can be stored locally within the memory of the electronic advertising device (152) and accessed by the electronic advertising device (152), for example, through a read and write operations to and from local memory, and in other ways as will occur to those of skill in the art.

In the example of FIG. 1, the electronic advertising device (152) is capable of identifying, through the camera (102) and the digital reference images, consumer products (114) within camera range (118) of the electronic advertising device (152). Identifying consumer products within the camera range of the electronic advertising device is carried out by capturing digital images of consumer products within camera range of the electronic advertising device (152). The images captured by the digital camera (102) are subsequently compared to digital reference images of consumer products to determine whether the captured image matches the digital reference image. In the example of FIG. 1, if the electronic advertising device determines that an image captured by the digital camera and a digital reference image are images of the same consumer product, the consumer product that is associated with the digital reference image is identified as a consumer product that is within camera range of the electronic advertising device.

In the example of FIG. 1, determining that a captured digital image and a digital reference image are images of the same consumer product is carried out through the use of digital image processing methodologies. Digital image processing, as the phrase is used here, refers to the use of computer algorithms to perform image processing and analysis of digital images, in effect, a form of computer vision. Such digital image processing algorithms are utilized in electronic advertising devices that operate according to embodiments of the present invention to determine the extent to which two or more digital images are similar. Digital image processing methodologies perform an image-to-image comparison that accounts for differences in image size, illumination levels, image orientation, and so on. Digital image processing methodologies also quantify the extent to which two or more digital images are similar, for example, by generating a similarity score that represents the percentage of points in a captured image and reference image that are identical, by generating a match reliability rating, and in other ways as will occur to those of skill in the art. In the example of FIG. 1, a similarity score or match reliability rating is compared to a predetermined threshold. If the similarity score or match reliability rating exceeds the predetermined threshold, the captured digital image and the digital reference image are determined to be images of the same consumer product. In some cases, given the resolution and zoom capabilities of the digital camera and the orientation of the consumer products (114), it may be possible to actually identify the product via recognition of the products UPC code (identifying numbers and/or the bar code) and using this scanned information as a key to identify the consumer product.

In the example of FIG. 1, the electronic advertising device (152) includes a chassis (105) upon which the camera (102) is rotatably mounted. In such an example, identifying consumer products (114) within camera range (118) of the electronic advertising device includes rotating the camera by the electronic advertising device. In the example of FIG. 1, the camera can be rotated in full 360 degree circles or rotated some lesser amount so as to only scan a particular area. The camera may be rotated through the use of a small motor mounted within the electronic advertising display (152), or in any other way as will occur to those of skill in the art.

In the example of FIG. 1, identifying consumer products (114) within camera range (118) of the electronic advertising device (152) includes capturing, by the camera as the camera rotates, digital images of consumer products within camera range of the electronic advertising device. Digital images of consumer products are captured as the camera rotates, for example, at predetermined intervals of time, at predetermined intervals of rotation, and so on. Because the digital camera captures digital images as the camera rotates, the electronic advertising device (152) receives digital images for products surrounding the electronic advertising device and the electronic advertising device (152) is thereby able to identify products that are within a radius of the electronic advertising device that is equal to the camera range (118) of the digital camera.

In the example of FIG. 1, identifying consumer products within camera range of the electronic advertising device (152) also includes matching, by the electronic advertising device (152), digital reference images with the captured digital images. Matching digital reference images with the captured digital images is carried out through the use of digital image processing methodologies as described above. Such digital image processing algorithms are utilized to determine the extent to which two or more digital images are similar. In the example of FIG. 1, if a captured digital image and a digital reference image are determined to be sufficiently similar, the two images are said to match.

In the example of FIG. 1, identifying consumer products within camera range of the electronic advertising device (152) also includes maintaining a list of the product identifiers associated with the matched digital reference images. Maintaining a list of the product identifiers is carried out through the use of an identified products table as illustrated in Table 2:

TABLE 2
Identified Products Table

| Consumer | | |
|---|---|---|
| Product | Consumer Product | Advertising |
| Identifier | Description | Content |
| 0001 | Potato Chips | //ads/ad1.wmv |
| 0008 | Bean Dip | //ads/ad8.jpg |
| 0015 | Cheese Dip | //ads/ad15.wmv |
| 0024 | Cashews | //ads/ad24.wmv |
| 0041 | Peanuts | //ads/ad41.jpg |

Each record in Table 2 represents a consumer product that is within camera range of the electronic advertising device. In the example of Table 2, each record associates an identifier for a consumer product with a consumer product description. Each record also associates an identifier for a consumer product with advertising content for the consumer product. Those of skill in the art will recognize that records in an identified products table, in addition to the fields shown in Table 2, can also include any information useful in maintaining a list of the product identifiers associated with the matched digital reference images as will occur to those of skill in the art. In addition, the table structure is used in this example only for clarity of explanation, not as a limitation of the underlying invention. Readers will recognize that a list of the product identifiers associated with the matched digital reference images may be implemented with a variety of data structures and storage arrangements as will occur to those of skill in the art, including, for example, records in a database, linked lists, multi-dimensional arrays, and so on, and the use of all such data structures and storage arrangements for maintaining a list of the product identifiers associated with the matched digital reference images is well within the scope of the present invention.

In the example of FIG. 1, the electronic advertising device (152) is also capable of displaying, in accordance with the rules, advertising content for the identified consumer products. The rules are predefined logic governing the particular advertising content to be displayed in response to determining that a particular consumer product is within camera range of the electronic advertising device. Advertising content for the identified consumer product is media content embodied in any form that can be displayed by the electronic advertising device. Advertising content can includes images of a product, video advertisements for a product such as a television commercial, and so on.

In the example of FIG. 1, the digital camera operates to identify consumer products within camera range of the digital camera. Readers will recognize that such a digital camera can be deployed for multiple uses. The digital camera may be used, for example, both as a security camera and for identifying consumer products within camera range as described above.

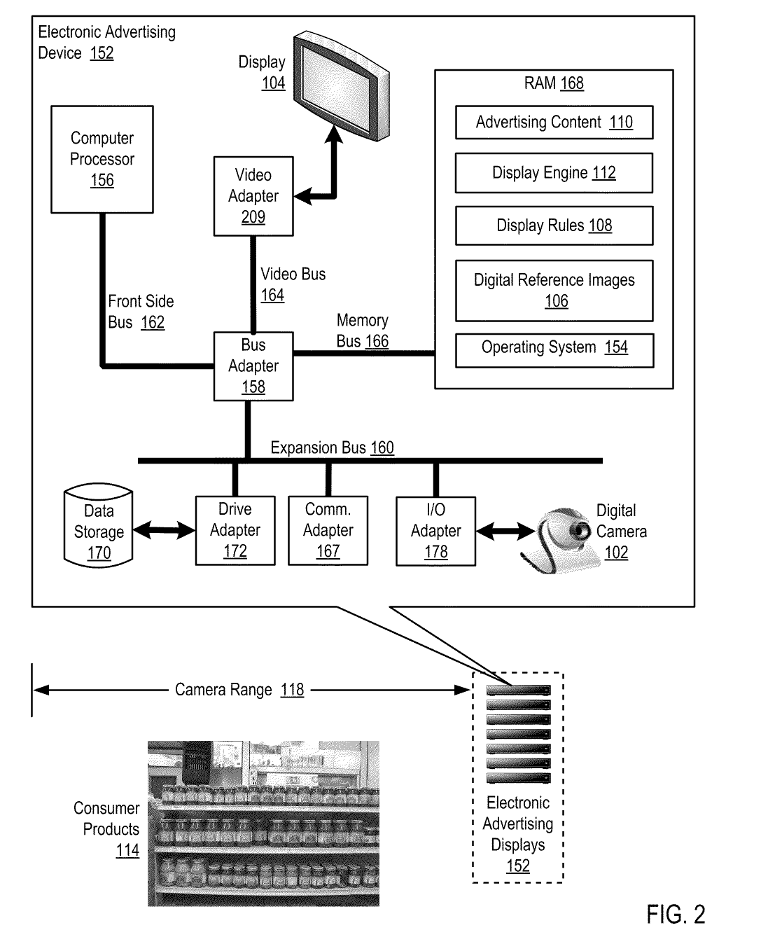

Operating an electronic advertising device in accordance with the present invention is generally implemented with computers, that is, with automated computing machinery. For further explanation, therefore, FIG. 2 sets forth a block diagram of automated computing machinery useful in operating an electronic advertising device according to embodiments of the present invention. The example of FIG. 2 includes an electronic advertising device (152) that is disposed within camera range (118) of consumer products (114) exhibited for sale.

The electronic advertising device (152) of FIG. 2 includes at least one computer processor (156), computer memory (168), a display (104), and a digital camera (102). In the example of FIG. 2, the random access memory (168) (‘RAM’) is connected through a high speed memory bus (166) and bus adapter (158) to the computer processor (156) and to other components of the electronic advertising device (152). In the example of FIG. 2, the computer processor is operatively coupled to the memory (168), the display (104), and the camera (104).

In the example of FIG. 2, the camera (102) is characterized by a camera range (118). A camera range is the distance from the camera within which the camera can effectively capture digital images of consumer products exhibited for sale. As described above with reference to FIG. 1, a digital image is effectively captured in the sense that the digital image is free of defects and the contents of the digital image can be identified.

In the example of FIG. 2, the electronic advertising device (152) is operatively coupled to data storage (168) containing digital reference images (106) of at least some of the consumer products exhibited for sale. Digital reference images (106) are digital images of known consumer products. Such consumer products are known in the sense that each digital reference image has a unique product identifier associated with the image.

In the example of FIG. 2, the electronic advertising device (152) is also operatively coupled to data storage (168) containing rules (108) for displaying advertising content for the consumer products exhibited for sale. The rules are predefined logic that identifies the particular advertising content that will be displayed in response to determining that a particular consumer product is within camera range of the electronic advertising device. In the example of FIG. 2, each rule includes at least one association of a consumer product with advertising content for that same consumer product.

In the example of FIG. 2, the electronic advertising device (152) is also operatively coupled to data storage (168) containing the advertising content (110) for the consumer products exhibited for sale. Advertising content is embodied as images of a product, audio commercials created for a product, video commercials created for a product, and so on.

In the example of FIG. 2, the digital reference images (106), display rules (108), and advertising content (110) are depicted as being stored in the RAM (168) of an electronic display device (152). Such a depiction is included only for the purpose of illustration and not as a limitation of the present invention. Digital reference images (106), display rules (108), and advertising contents (110) can be stored remotely and accessed by the electronic advertising device (152), for example, through a Local Area Network (‘LAN’) and in other ways as will occur to those of skill in the art.

Stored in RAM (168) is a display engine (112), a module of computer program instructions for operating an electronic advertising device. The display engine (112) of FIG. 2 operates generally by identifying consumer products (114) within camera range (118) of the electronic advertising device and displaying, in accordance with the rules, advertising content for the identified consumer products as described above with reference to FIG. 1. The display engine (112) also includes computer program instructions for operating the digital camera (102), including computer program instructions to capture a digital image, rotate the camera, and so on.

Also stored in RAM (168) is an operating system (154). Operating systems useful for operating an electronic advertising device according to embodiments of the present invention include UNIX™, Linux™, Microsoft XP™, AIX™, IBM's i5/OS™, and others as will occur to those of skill in the art. The operating system (154), advertising content (110), display engine (112), display rules (108), and digital reference images (106) in the example of FIG. 2 are shown in RAM (168), but many components of such software typically are stored in non-volatile memory also, such as, for example, on a disk drive (170).

The electronic advertising device (152) of FIG. 2 includes a disk drive adapter (172) coupled through expansion bus (160) and bus adapter (158) to processor (156) and other components of the electronic advertising device (152). Disk drive adapter (172) connects non-volatile data storage to the electronic advertising device (152) in the form of disk drive (170). Disk drive adapters useful in operating an electronic advertising device according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example electronic advertising device (152) of FIG. 2 includes one or more input/output (‘I/O’) adapters (178). I/O adapters implement user-oriented input/output through, for example, software drivers and computer hardware for controlling output to display devices such as computer display screens, as well as input from user input devices such as a digital camera (102). The example electronic advertising device (152) of FIG. 2 includes a video adapter (209), which is an example of an I/O adapter specially designed for graphic output to a display device (104) such as a display screen or computer monitor. Video adapter (209) is connected to processor (156) through a high speed video bus (164), bus adapter (158), and the front side bus (162), which is also a high speed bus.

The example electronic advertising device (152) of FIG. 2 includes a communications adapter (167) for data communications with other computers and for data communications with a data communications network. Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for operating an electronic advertising device according to embodiments of the present invention include modems for wired dial-up communications, Ethernet (IEEE 802.3) adapters for wired data communications network communications, and 802.11 adapters for wireless data communications network communications.

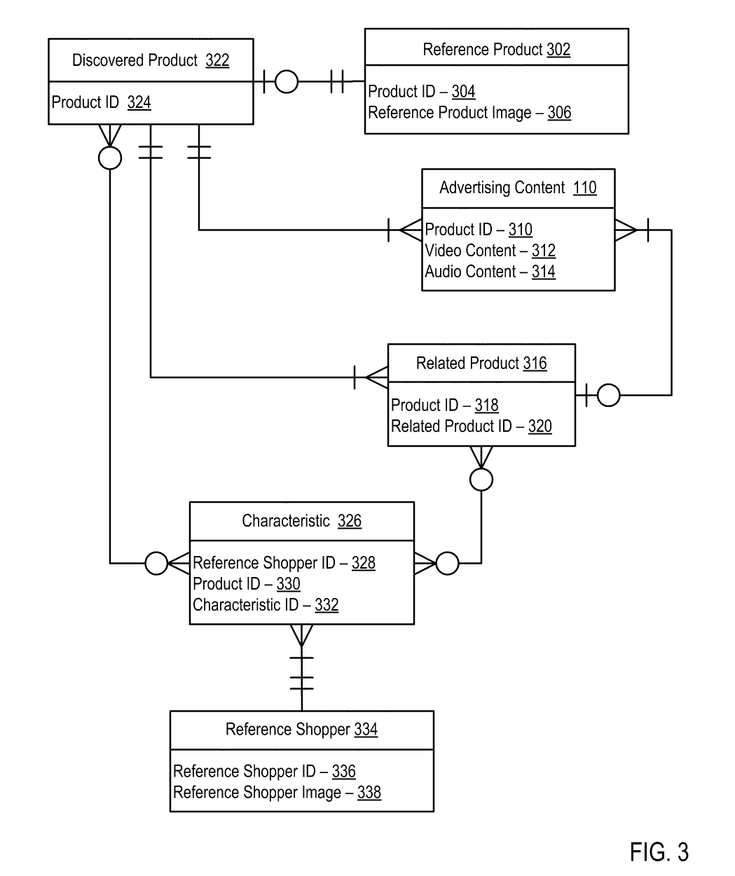

For further explanation, FIG. 3 sets forth an entity relationship diagram of several example data structures useful in operating an electronic advertising device according to embodiments of the present invention. Such data structures are usually stored in RAM (168 on FIG. 2) or, for longer-term or non-volatile storage, on a hard disk (170 on FIG. 2) or other non-volatile storage as will occur to those of skill in the art. The example data structures of FIG. 3, for clarity of explanation, are shown related as tables in a database, although other data storage arrangements as will occur to those of skill in the art are possible, linked lists, memory arrays, C-style structs, and so on, all such arrangements being well within the scope of the present invention.

The example structures of FIG. 3 include a reference product table (302). Each record in such a table represents a known consumer product. Such a consumer product is ‘known’ in the sense that the consumer product includes an associated product identifier (304) and a visual appearance as depicted in the reference product image (306). The product identifier (304) is a unique identifier that is used to identify a specific consumer product. The reference product image (306) is a digital image of the consumer product associated with a product identifier (304) for use in computer vision applications. In this example, the product identifier (304) may be embodied as an integer, character string, and in any other way that will occur to those of skill in the art. The reference product image (306) may be embodied, for example, as a URL that points to a digital image stored remotely in cyberspace at the location identified by the URL, a path name in a local storage directory that points to a digital image stored on a local disk drive, and so on.

The example structures of FIG. 3 also include an advertising content table (110). Each record in such a table represents advertising content for a particular product. Each record in such a table includes a product identifier (310) that represents a consumer product, video content (312) that represents video advertising content for the consumer product, and audio content (314) that represents audio advertising content for the consumer product. In this example, the product identifier (310) may be embodied as an integer, character string, and in any other way that will occur to those of skill in the art. The video content (310) and audio content (312) may be embodied, for example, as URLs that point to video and audio files stored remotely in cyberspace at the location identified by the URL, a path name in a local storage directory that points video and audio files stored on a local disk drive, and so on.

The example structures of FIG. 3 also include a reference shopper table (334). Each record in such a table represents a known reference shopper. Such shoppers are known in the sense that an image of the reference shopper is associated with a reference shopper identifier. Each record in such a table includes a reference shopper identifier (336) and a reference shopper image (338). A reference shopper identifier (336) is embodied as an integer, character string, or in any other way that will occur to those of skill in the art. A reference shopper image (338) is a digital image of a shopper associated with a reference shopper identifier (336). A reference shopper image (338) is embodied as a URL that points to a digital image, a path name in a local storage directory that points to a digital image, and so on.

The example structures of FIG. 3 also include an related product table (316), which is related to advertising content (110) through product identifier (318) as a foreign key and is also related to shopper characteristics (326) through product identifier (318). Each record in the related product table (316) table represents a consumer product that is related to a consumer product that has been identified as being within camera range of the electronic advertising device. Products can be related in the sense that the products are viewed as being complementary products, such as peanut butter and jelly, the products are viewed as being possible substitutes, such as cake mix and brownie mix, or for other reasons as may occur to those of skill in the art. In the example of FIG. 3, each related product record includes a product identifier (318) and a related product identifier (320). A product identifier (318) is a unique identifier that is used to identify a specific consumer product that is within camera range of the electronic advertising device. A related product identifier (320) is a unique identifier that is used to identify a specific consumer product that is related to a consumer product that is within camera range of the electronic advertising device. The product identifier (318) and the related product identifier (320) are embodied as an integer, character string, or in any other way that will occur to those of skill in the art.

The example structures of FIG. 3 also include a discovered product table (322). Each record in such a table represents a consumer product that has been identified as being within camera range of the electronic advertising device. In the example of FIG. 3, each discovered product record includes a product identifier (324). A product identifier (324) is a unique identifier that is used to identify a specific consumer product that has been identified as being within camera range of the electronic advertising device. The product identifier is embodied as an integer, character string, or in any other way that will occur to those of skill in the art. The product identifier (324) is used here as a foreign key relating several other tables to the discovered product table (322), including reference products (302), advertising content (110), related products (316), and shopper characteristics (326).

The example structures of FIG. 3 also include a characteristics table (326), related to the shopper characteristics table (326) through the reference shopper identifier (336) as a foreign key. Each record in such a table represents a particular characteristic of a shopper. In the example of FIG. 3, each record in such a table includes a reference shopper identifier (328), a product identifier (330), and a characteristic identifier (332). A reference shopper identifier (328) is a unique identifier of a reference shopper, and a characteristic identifier (332) is a unique identifier that is associated with a specific characteristic of a shopper. Examples of shopper characteristics include the sex of the shopper, other physical characteristics of the shopper, and characteristics of the shopper that can be inferred from a shopper's appearance. A shopper may be characterized, for example, as being male, female, bald, overweight, a New York Yankees fan, and so on. A product identifier (330) is a unique identifier that is used to identify a specific consumer product that has been identified as being within camera range of the electronic advertising device. The characteristic identifier (328) and the product identifier (330) are embodied as an integer, character string, and in any other way that will occur to those of skill in the art.

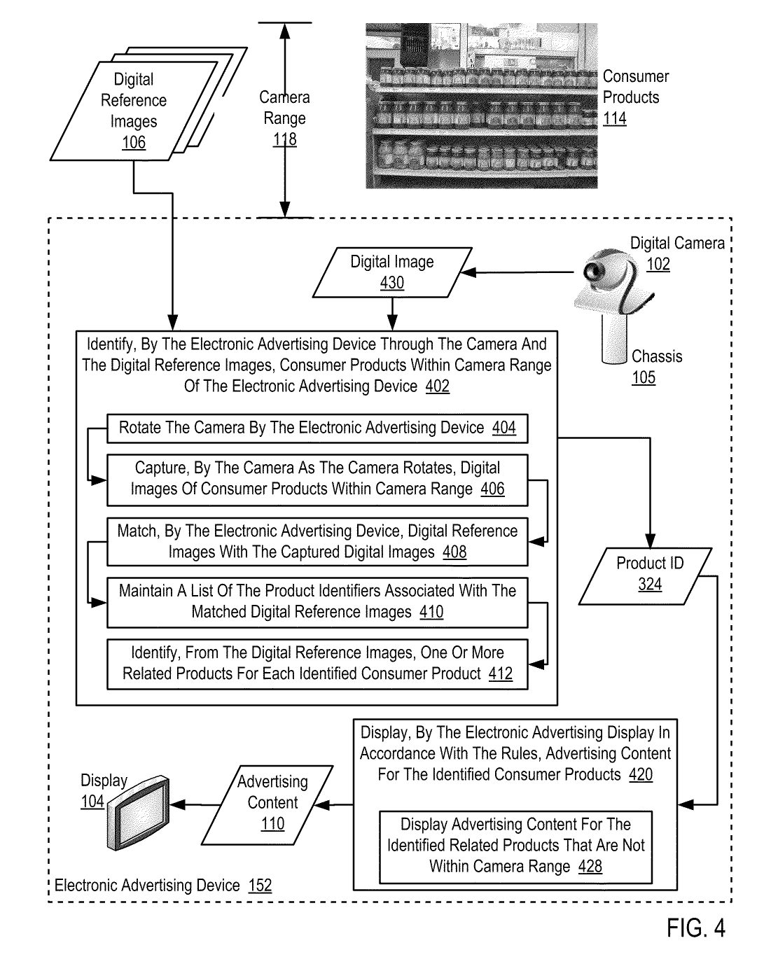

For further explanation, FIG. 4 sets forth a flow chart illustrating an example method of operating an electronic advertising device (152) according to embodiments of the present invention. In the method of FIG. 4, the electronic advertising device (152) is disposed within camera range (118) of consumer products (114) exhibited for sale. The electronic advertising device of FIG. 4 is similar to the electronic advertising devices described in FIGS. 1 and 2, including as it does, a display (104), a digital camera (102), digital reference images (106), advertising content (110), and so on. In the method of FIG. 4, the advertising display device (152) also includes a chassis (105) upon which the camera is rotatably mounted and each digital reference image (106) is associated with an identifier of a consumer product. Associating digital reference images with consumer product identifiers is carried out by use of a reference image table as illustrated in Table 1.

The method of FIG. 4 includes identifying (402), by the electronic advertising device (152) through the camera (102) and the digital reference images (106), consumer products (114) within camera range (118) of the electronic advertising device. In the method of FIG. 4, identifying consumer products includes rotating (404) the camera by the electronic advertising device (152). Rotating the camera is carried out, for example, through the use of a motor that resides within the electronic advertising device. In the example of FIG. 4, the camera can be rotated in full 360 degree circles or rotated some lesser amount so as to only scan a particular area.

In the method of FIG. 4, identifying consumer products also includes capturing (406), by the camera (102) as the camera rotates, digital images of consumer products (114) within camera range (118). Digital images of consumer products can be captured, as the camera rotates, at predetermined intervals of time, at predetermined intervals of rotation, and so on. Because the digital camera captures digital images as the camera rotates, the electronic advertising device receives digital images for products surrounding the electronic advertising device and the electronic advertising device is thereby able to identify products that are within a radius of the electronic advertising device that is equal to the camera range of the digital camera.

In the method of FIG. 4, identifying consumer products also includes matching (408), by the electronic advertising device (152), digital reference images (106) with the captured digital images (430). Matching digital reference images with the captured digital images is, in effect for each such match, a determination that a captured image and a reference image are both images of the same consumer product. Determining that a captured digital image and a digital reference image are images of the same consumer product in this example is carried out through the use of digital image processing methodologies. As mentioned earlier, digital image processing is the use of computer algorithms to perform image processing and analysis of digital images, a form of computer vision. Such digital image processing algorithms are utilized in electronic advertising devices that operate according to embodiments of the present invention to determine the extent to which two or more digital images are similar. Digital image processing methodologies perform an image-to-image comparison that accounts for differences in image size, illumination levels, image orientation, and so on. Digital image processing also quantifies the extent to which two or more digital images are similar, for example, by generating a similarity score that represents the percentage of points in a captured image and reference image that are identical, by generating a match reliability rating, and in other ways as will occur to those of skill in the art. In the example of FIG. 4, a similarity score or match reliability rating is compared to a predetermined threshold. If the similar score or match reliability rating exceeds the predetermined threshold, the captured digital image and the digital reference image are determined to be images of the same consumer product.

In the method of FIG. 4, identifying consumer products also includes maintaining (410) a list of the product identifiers associated with the matched digital reference images. Maintaining a list of the product identifiers is carried out, for example, through the use of an identified products table as illustrated and described above with reference to Table 2. Readers will recognize that a list of the product identifiers associated with the matched digital reference images may be implemented with a variety of data structures and storage arrangements as will occur to those of skill in the art, including records in a database, linked lists, multi-dimensional arrays, and so on, and the use of all such data structures and storage arrangements for maintaining a list of the product identifiers associated with the matched digital reference images is well within the scope of the present invention.

In the method of FIG. 4, each digital reference image (106) represents a consumer product, each digital reference image is associated with an identifier of the consumer product represented by the digital reference image, and each digital reference image is also associated with one or more identifiers of related products. Associating each digital reference image with an identifier of the consumer product represented by the digital reference image is carried out, for example, through the use of a table such as Table 1. Each digital reference image can also be associated with one or more identifiers of related products, for example, through the use of a related products table as illustrated in Table 3:

TABLE 3
Related Products Table

| Digital | Consumer | Consumer | Related | Related |
|---|---|---|---|---|
| Reference | Product | Product | Product | Product |
| Image | Identifier | Description | Identifier | Description |
| //images/img1.jpg | 0001 | Chips | 0034 | Bean Dip |
| //images/img2.jpg | 0002 | Cola | 0016 | Ice |
| //images/img3.jpg | 0003 | Beer | 0062 | Aspirin |
| //images/img4.jpg | 0004 | Pasta | 0011 | Pesto |
| //images/img5.jpg | 0005 | Bread | 0027 | Butter |

Each record in Table 3 represents a relationship between two consumer products. In Table 3, each record associates a consumer product identified by a consumer product identifier with another consumer product identified by a related product identifier. Each record in Table 3 also associates a digital reference image of the consumer product associated with the consumer product identifier with a related product identified by the related product identifier. A digital reference image is therefore associated with one or more identifiers of related products because the digital reference image is associated with a consumer product identifier, which is in turn associated with a related product identifier in Table 3.

In the method of FIG. 4, identifying consumer products within camera range also includes identifying (412), from the digital reference images, one or more related products for each identified consumer product. In the example of FIG. 4, consumer products within camera range are identified capturing a digital image with a digital camera, comparing the captured image to digital reference images, and identifying a match between the captured image and a digital reference image that is associated with a known consumer product as described above. The consumer product identifier of the consumer product that is within camera range of the electronic advertising device is subsequently used to identify one or more related products, for example, through the use of a related products table such as Table 3.

The method of FIG. 4 also includes displaying (420), by the electronic advertising device in accordance with the rules, advertising content (110) for the identified consumer products. The rules are predefined logic governing the particular advertising content to be displayed in response to determining that a particular consumer product is within camera range of the electronic advertising device. Advertising content (110) for the identified consumer product includes media content is embodied in any form that can be displayed by the electronic advertising device. Such advertising content (110) can include images of a product, video advertisements for a product such as a television commercial, and so on.

In the method of FIG. 4, displaying (420) advertising content also includes displaying (428) advertising content for the identified related products that are not within camera range. Displaying advertising content for the identified related products is carried out by using the related product identifier of the related product to retrieve advertising content (110) for the product associated with the related product identifier. In the example of FIG. 4, if the related product identifier is not found in any record in the identified products table, Table 2, then the related product is determined to be outside of the camera range of the electronic advertising device since the electronic advertising device has not captured a digital image that matches the related product. Retrieving advertising content for the product associated with the related product identifier is carried out by using the related product identifier as the consumer product identifier and searching for advertising content associated with such a consumer product identifier, for example, in Table 1. Upon retrieving advertising content associated with the consumer product identifier, such advertising content is displayed on the display screen of the electronic advertising device.

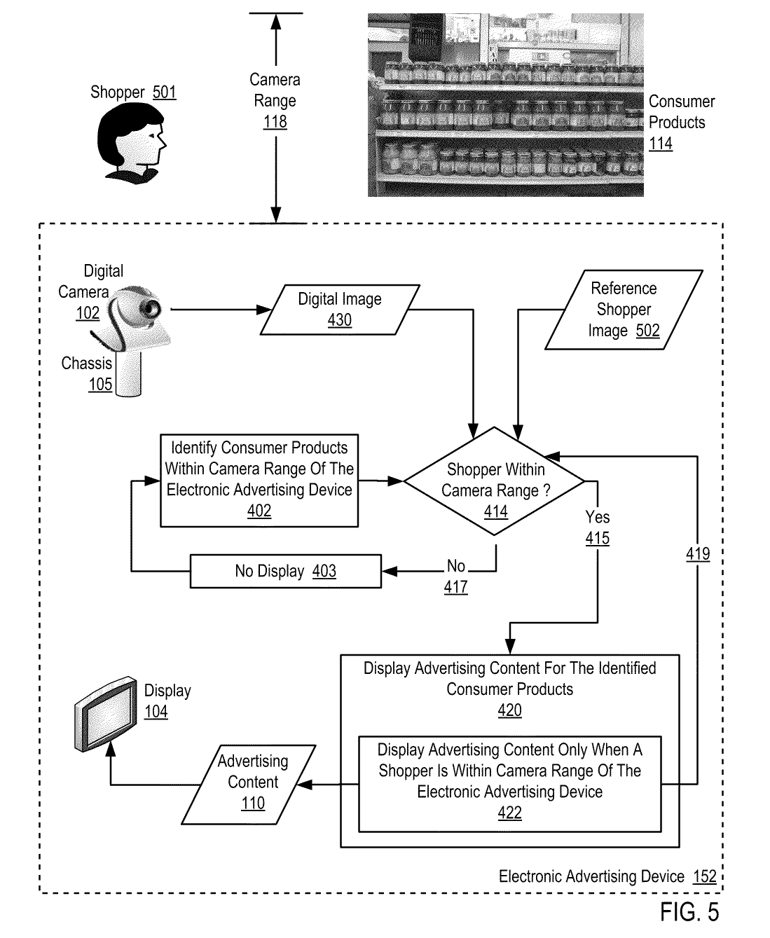

FIG. 5 sets forth a flow chart illustrating a further example method of operating an electronic advertising device (152) according to embodiments of the present invention. The method of FIG. 5 is similar to the method of FIG. 4, including as it does, identifying (402) consumer products within camera range of the electronic advertising device (152) and displaying (420) advertising content for the identified consumer product. Also like the example of FIG. 4, the electronic advertising device (152) in the example of FIG. 5 is disposed within camera range (118) of consumer products (114) exhibited for sale. The electronic advertising device of FIG. 5 is also generally similar to the electronic advertising devices described in FIGS. 1 and 2, including as it does, a display (104), a digital camera (102), digital reference images (106), advertising content (110), and so on.

The method of FIG. 5, however, also includes determining (414), by the electronic advertising device (152) through the camera (102), whether a shopper (501) is within camera range (118) of the electronic advertising device (152). Determining (414) whether a shopper is within camera range of the electronic advertising device (152) is carried out by determining whether a shopper appears in digital images (430) captured by the digital camera. Determining whether a shopper appears in the digital images captured by the digital camera is carried out by comparing captured digital images to reference shopper images (502). Reference shopper images (502) are images of items associated with shoppers and images of shoppers. Such images can include, for example, images of a human face, shapes of a human body, items worn by a shopper, such as a shirt, hat, pants, shoes, and items carried by shoppers, such as a purse, backpack, and so on. When one of more of these items is identified in a captured digital image, it is determined that a shopper is within camera range of the electronic advertising device.

In the method of FIG. 5, displaying advertising content includes displaying (422) advertising content only when a shopper (501) is (415) within camera range (118) of the electronic advertising device (152). Displaying advertising content only when a shopper is within camera range of the electronic advertising device is carried out by displaying advertising content (110) and then looping (419) to a further determination (414) whether a shopper is within camera range and continuing to so display advertising content until eventually a determination is made (417) that no shopper is within camera range.

When no shopper (417) is within camera range of the electronic advertising device, the electronic advertising device presents no display (403) of advertising content. In the method of FIG. 5, even when the electronic advertising device ceases to display advertising content, the digital camera continues to capture digital images, each of which is examined both to identify (402) consumer products within camera range and also to determine whether a shopper is within camera range of the electronic advertising device, thereby causing the electronic advertising device to resume displaying advertising contents when a shopper does come within camera range of the electronic advertising device.

In the method of FIG. 5, the electronic advertising device is capable of differentiating between employees and shoppers so that advertising content will not be displayed in response to detecting the presence of an employee. Differentiating between employees and shoppers can be carried out, for example, by comparing digital images captured by the digital camera to reference employee images. Reference employee images can include, for example, images of an employee badge, images of a vest worm by employees, and so on. Upon determining that a captured digital image and a reference employee image are images of the same item associated with an employee, the electronic advertising device (152) can effectively ignore the presence of the employee by not displaying advertising material in response to the presence of the employee.

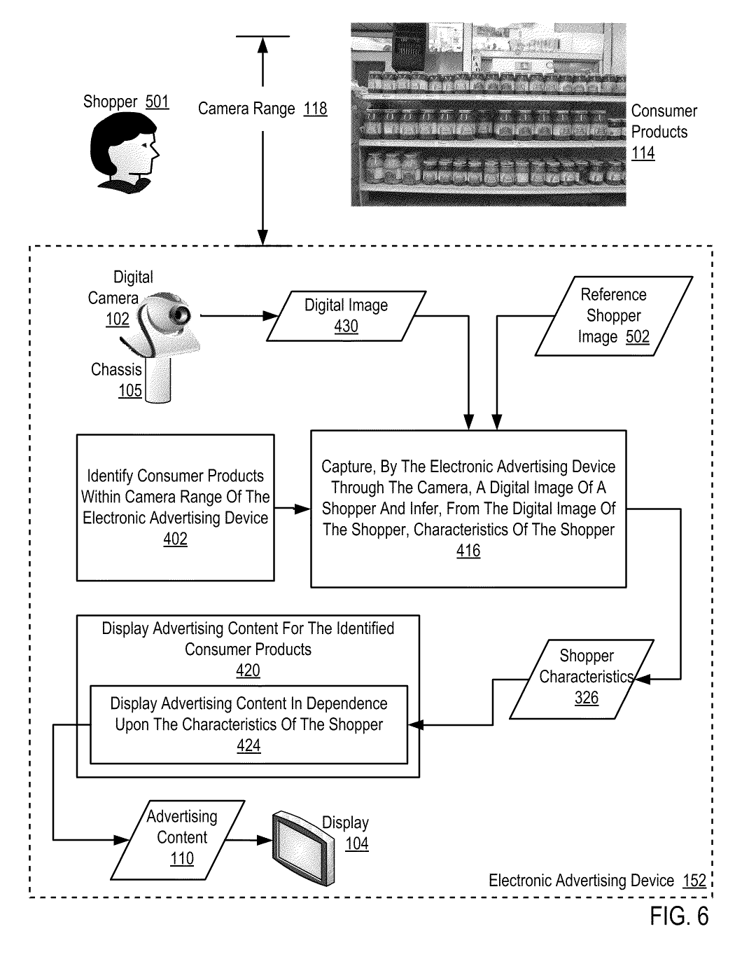

FIG. 6 sets forth a flow chart illustrating a further example method of operating an electronic advertising device (152) according to embodiments of the present invention. The method of FIG. 6 is similar to the method of FIG. 4, including as it does, identifying (402) consumer products within camera range of the electronic advertising device (152) and displaying (420) advertising content for the identified consumer product. Also like the example of FIG. 4, the electronic advertising device (152) in the example of FIG. 6 is disposed within camera range (118) of consumer products (114) exhibited for sale. The electronic advertising device of FIG. 6 is also generally similar to the electronic advertising devices described in FIGS. 1 and 2, including as it does, a display (104), a digital camera (102), digital reference images (106), advertising content (110), and so on.

The method of FIG. 6 includes capturing (416), by the electronic advertising device through the camera, a digital image of a shopper and inferring, from the digital image of the shopper, characteristics of the shopper. In the method of FIG. 6, inferring characteristics of the shopper is carried out by matching captured digital images (430) to reference shopper images (502). Reference shopper images may include, for example, images of a bald head, images of average male and female bodies, an image of a New York Yankees baseball cap, and so on. Upon detecting a match between such a reference shopper image (502) and a captured digital image (430), the electronic advertising device infers that there is a shopper in the area that exhibits characteristics associated with the reference shopper image.

Consider an example in which the electronic advertising display compares a captured image to a reference shopper image and determines that the digital camera has captured an image of a New York Yankees baseball cap. In such an example, the electronic advertising display infers that a shopper with the characteristic of being a New York Yankees fan is within camera range of the electronic advertising device. Inferring such a characteristic causes the electronic advertising device to display advertising content that has been predetermined to be of interest to such a shopper, for example, by displaying advertising content for New York Yankee jerseys that are available for purchase in the store. In the example of FIG. 6, reference shopper images, shopper characteristic identifiers, and consumer product identifiers are associated, for example, in a shopper characteristic table as illustrated in Table 4:

TABLE 4
Shopper Characteristic Table

| Reference | Reference | Shopper | Consumer |
|---|---|---|---|
| Shopper | Shopper | Characteristic | Product |
| Image | ID | ID | Identifier |
| //shoppers/img1.jpg | 0001 | 0001 | 0004 |
| //shoppers/img2.jpg | 0002 | 0002 | 0004 |
| //shoppers/img3.jpg | 0003 | 0003 | 0002 |
| //shoppers/img4.jpg | 0004 | 0004 | 0005 |
| //shoppers/img5.jpg | 0005 | 0005 | 0001 |

Each record in Table 4 represents a shopper characteristic. In the example of Table 4, each record associates a reference shopper image with a reference shopper identifier, a shopper characteristic identifier, and a consumer product identifier. In this example, each record of Table 4 associates a reference shopper with a single consumer product. Readers will recognize, however, a reference shopper identifier can be used as foreign key into a table that associates such a key with many consumer product identifiers, such as, for example, the shopper characteristics table (326 on FIG. 3). Also in this example, each record of Table 4 associates a reference shopper with a shopper chrematistic. The reference shopper identifier similarly can be used as foreign key into a table that associates such a key with many shopper characteristics. Those of skill in the art will recognize that records in a shopper characteristic table, in addition to the fields shown in Table 4, can also include any information useful in inferring characteristics of the shopper as will occur to those of skill in the art. As usual in this specification, the table structure is used in this example only for clarity of explanation, not as a limitation of the underlying invention.

In the method of FIG. 6, displaying (420) advertising content includes displaying (424) advertising content in dependence upon the characteristics of the shopper. Displaying advertising content in dependence upon the characteristics of the shopper is carried out by displaying advertising content for a consumer product associated with an identified shopper characteristic. Displaying advertising content for a consumer product associated with an identified shopper characteristic is carried out by retrieving the consumer product identifier associated with a shopper characteristic ID as defined in Table 4. The retrieved product identifier is subsequently used to retrieve advertising content (110) associated with the consumer product identifier as defined in Table 1. Upon retrieving advertising content (110) associated with the consumer product identifier, such advertising content (110) is displayed on the electronic advertising device.

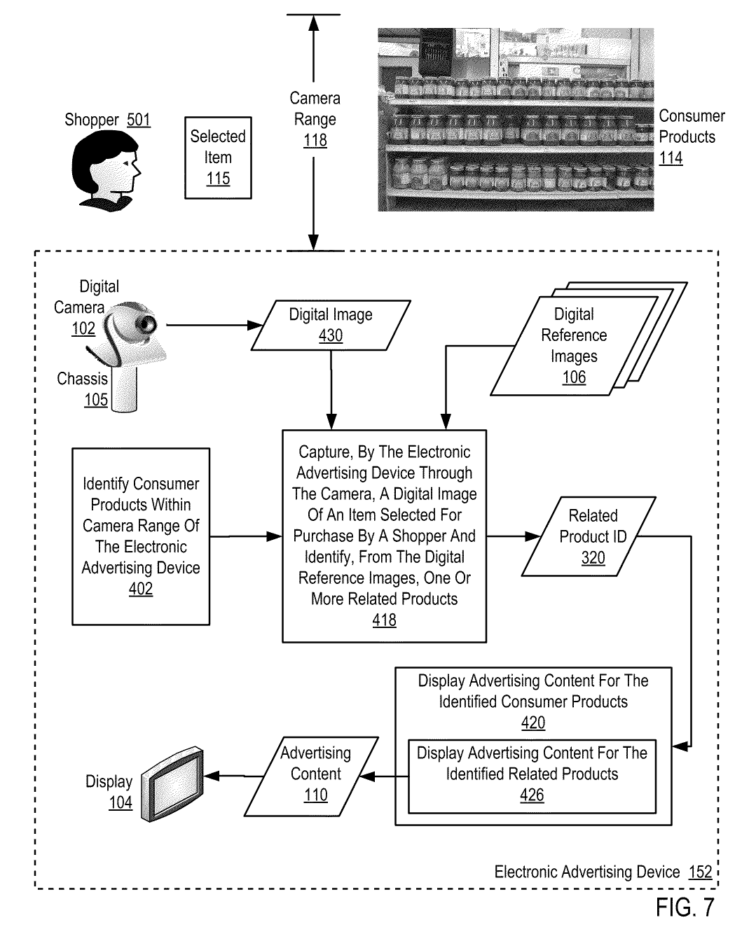

FIG. 7 sets forth a flow chart illustrating a further example method of operating an electronic advertising device (152) according to embodiments of the present invention. The method of FIG. 7 is similar to the method of FIG. 4, including as it does, identifying (402) consumer products within camera range of the electronic advertising device (152) and displaying (420) advertising content for the identified consumer product. Also like the example of FIG. 4, the electronic advertising device (152) in the example of FIG. 7 is disposed within camera range (118) of consumer products (114) exhibited for sale. The electronic advertising device of FIG. 7 is also generally similar to the electronic advertising devices described in FIGS. 1 and 2, including as it does, a display (104), a digital camera (102), digital reference images (106), advertising content (110), and so on.

The method of FIG. 7 also includes capturing (418), by the electronic advertising device through the camera, a digital image of an item selected for purchase by a shopper and identifying, from the digital reference images, one or more related products. In the example of FIG. 7, capturing a digital image of an item selected for purchase by a shopper is carried out by capturing digital images at predetermined intervals and determining that a shopper is in camera range of the electronic advertising device as described above. In the example of FIG. 7, if a shopper is in camera range of the electronic advertising device, the electronic advertising device attempts to identify items selected for purchase by the shopper. Identifying items selected for purchase by the shopper is carried out by comparing captured digital images of products in a shopper's shopping cart or shopping basket to digital reference images of consumer products. If the consumer products selected for purchase by the shopper are identified, one or more related products can be identified by retrieving the related product identifier (320) that is associated with the consumer product selected for purchase by the shopper as defined, for example, in a related products table such as Table 4 as described above with reference to FIG. 4.

In the method of FIG. 7, displaying advertising content also includes displaying (426) advertising content for the identified related products. Displaying (426) advertising content for the identified related products is carried out by using the related product identifier retrieved above to retrieve advertising content for the product associated with the related product identifier (320). Retrieving advertising content for the product associated with the related product identifier is carried out by using the related product identifier as the consumer product identifier and searching Table 2 for advertising content associated with such a consumer product identifier. Upon retrieving advertising content associated with the consumer product identifier, such advertising content can be displayed on the electronic advertising device through a video display (104), audio output, or the like.

Example embodiments of the present invention are described largely in the context of a fully functional electronic advertising device. Readers of skill in the art will recognize, however, that the present invention also may be embodied in a computer program product disposed on recordable media for machine-readable information, including magnetic media, optical media, or other suitable media. Examples of recordable media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a program product. Persons skilled in the art will recognize immediately that, although some of the example embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of operating an electronic advertising device, the electronic advertising device disposed within camera range of consumer products exhibited for sale, the electronic advertising device comprising:
at least one computer processor, computer memory, a display, and a digital camera, the processor operatively coupled to the memory, the display, and the camera; the camera characterized by the camera range, the camera range being a distance from the camera within which the camera can effectively capture digital images of consumer products exhibited for sale;
the electronic advertising device operatively coupled to data storage containing digital reference images of at least some of the consumer products exhibited for sale; the electronic advertising device also operatively coupled to data storage containing rules for displaying advertising content for the consumer products exhibited for sale, each rule comprising at least one association of a consumer product with advertising content for that same consumer product; the electronic advertising device also operatively coupled to data storage containing the advertising content for the consumer products exhibited for sale;
the method comprising:
identifying, by the electronic advertising device through the camera and the digital reference images, consumer products within camera range of the electronic advertising device; and
displaying, by the electronic advertising device in accordance with the rules, advertising content for the identified consumer products.

2. The method of claim 1 wherein the device further comprises a chassis upon which the camera is rotatably mounted, each digital reference image is associated with an identifier of a consumer product, and identifying consumer products further comprises:
rotating the camera by the electronic advertising device;
capturing, by the camera as the camera rotates, digital images of consumer products within camera range;
matching, by the electronic advertising device, digital reference images with the captured digital images; and
maintaining a list of the product identifiers associated with the matched digital reference images.

3. The method of claim 1 wherein:
the method further comprises determining, by the electronic advertising device through the camera, whether a shopper is within camera range of the electronic advertising device; and
displaying advertising content further comprises displaying advertising content only when a shopper is within camera range of the electronic advertising device.

4. The method of claim 1 wherein:
the method further comprises capturing, by the electronic advertising device through the camera, a digital image of a shopper and inferring, from the digital image of the shopper, characteristics of the shopper; and
displaying advertising content further comprises displaying advertising content in dependence upon the characteristics of the shopper.

5. The method of claim 1 wherein:
each digital reference image is associated with one or more identifiers of related products;
the method further comprises capturing, by the electronic advertising device through the camera, a digital image of an item selected for purchase by a shopper and identifying, from the digital reference images, one or more related products; and
displaying advertising content further comprises displaying advertising content for the identified related products.

6. The method of claim 1 wherein:
each digital reference image represents a consumer product, each digital reference image is associated with an identifier of the consumer product represented by the digital reference image, and each digital reference image is also associated with one or more identifiers of related products;
identifying consumer products within camera range further comprises identifying, from the digital reference images, one or more related products for each identified consumer product; and
displaying advertising content further comprises displaying advertising content for the identified related products that are not within camera range.

7. An electronic advertising device, the electronic advertising device disposed within camera range of consumer products exhibited for sale, the electronic advertising device comprising:
at least one computer processor, computer memory, a display, and a digital camera, the processor operatively coupled to the memory, the display, and the camera; the camera characterized by the camera range, the camera range being a distance from the camera within which the camera can effectively capture digital images of consumer products exhibited for sale;
the electronic advertising device operatively coupled to data storage containing digital reference images of at least some of the consumer products exhibited for sale; the electronic advertising device also operatively coupled to data storage containing rules for displaying advertising content for the consumer products exhibited for sale, each rule comprising at least one association of a consumer product with advertising content for that same consumer product; the electronic advertising device also operatively coupled to data storage containing the advertising content for the consumer products exhibited for sale;
the computer memory having disposed within it computer program instructions which, when executed, cause the electronic advertising device to carry out the steps of:
identifying, through the camera and the digital reference images, consumer products within camera range of the electronic advertising device; and
displaying, in accordance with the rules, advertising content for the identified consumer products.

8. The electronic advertising device of claim 7 wherein the electronic advertising device further comprises a chassis upon which the camera is rotatably mounted,
each digital reference image is associated with an identifier of a consumer product, and identifying consumer products further comprises:
rotating the camera by the electronic advertising device;
capturing, by the camera as the camera rotates, digital images of consumer products within camera range;
matching, by the electronic advertising device, digital reference images with the captured digital images; and
maintaining a list of the product identifiers associated with the matched digital reference images.

9. The electronic advertising device of claim 7 wherein:
the electronic advertising device further comprises computer program instructions capable of causing the electronic advertising device to carry out the step of determining through the camera whether a shopper is within camera range of the electronic advertising device; and
displaying advertising content further comprises displaying advertising content only when a shopper is within camera range of the electronic advertising device.

10. The electronic advertising device of claim 7 wherein:
the electronic advertising device further comprises computer program instructions capable of causing the electronic advertising device to carry out the step of capturing through the camera a digital image of a shopper and inferring, from the digital image of the shopper, characteristics of the shopper; and
displaying advertising content further comprises displaying advertising content in dependence upon the characteristics of the shopper.

11. The electronic advertising device of claim 7 wherein:
each digital reference image is associated with one or more identifiers of related products;
the electronic advertising device further comprises computer program instructions capable of causing the electronic advertising device to carry out the step of capturing through the camera a digital image of an item selected for purchase by a shopper and identifying, from the digital reference images, one or more related products; and
displaying advertising content further comprises displaying advertising content for the identified related products.

12. The electronic advertising device of claim 7 wherein:
each digital reference image represents a consumer product, each digital reference image is associated with an identifier of the consumer product represented by the digital reference image, and each digital reference image is also associated with one or more identifiers of related products;
identifying consumer products within camera range further comprises identifying, from the digital reference images, one or more related products for each identified consumer product; and
displaying advertising content further comprises displaying advertising content for the identified related products that are not within camera range.

13. A computer program product for operating an electronic advertising device, the electronic advertising device disposed within camera range of consumer products exhibited for sale, the electronic advertising device comprising:
at least one computer processor, computer memory, a display, and a digital camera, the processor operatively coupled to the memory, the display, and the camera; the camera characterized by the camera range, the camera range being a distance from the camera within which the camera can effectively capture digital images of consumer products exhibited for sale;
the electronic advertising device operatively coupled to data storage containing digital reference images of at least some of the consumer products exhibited for sale; the electronic advertising device also operatively coupled to data storage containing rules for displaying advertising content for the consumer products exhibited for sale, each rule comprising at least one association of a consumer product with advertising content for that same consumer product; the electronic advertising device also operatively coupled to data storage containing the advertising content for the consumer products exhibited for sale;
the computer program product disposed upon a computer-readable recording medium, the computer program product comprising computer program instructions which, when executed, cause automated computing machinery to carry out the steps of:
identifying, by the electronic advertising device through the camera and the digital reference images, consumer products within camera range of the electronic advertising device; and
displaying, by the electronic advertising device in accordance with the rules, advertising content for the identified consumer products.

14. The computer program product of claim 13 wherein the device further comprises a chassis upon which the camera is rotatably mounted, each digital reference image is associated with an identifier of a consumer product, and identifying consumer products further comprises:
rotating the camera by the electronic advertising device;
capturing, by the camera as the camera rotates, digital images of consumer products within camera range;
matching, by the electronic advertising device, digital reference images with the captured digital images; and
maintaining a list of the product identifiers associated with the matched digital reference images.

15. The computer program product of claim 13 wherein:
the computer program product comprises computer program instructions which, when executed, cause automated computing machinery to carry out the step of determining, by the electronic advertising device through the camera, whether a shopper is within camera range of the electronic advertising device; and
displaying advertising content further comprises displaying advertising content only when a shopper is within camera range of the electronic advertising device.

16. The computer program product of claim 13 wherein:
the computer program product comprises computer program instructions which, when executed, cause automated computing machinery to carry out the step of capturing, by the electronic advertising device through the camera, a digital image of a shopper and inferring, from the digital image of the shopper, characteristics of the shopper; and
displaying advertising content further comprises displaying advertising content in dependence upon the characteristics of the shopper.

17. The computer program product of claim 13 wherein:
each digital reference image is associated with one or more identifiers of related products;
the computer program product comprises computer program instructions which, when executed, cause automated computing machinery to carry out the step of capturing, by the electronic advertising device through the camera, a digital image of an item selected for purchase by a shopper and identifying, from the digital reference images, one or more related products; and
displaying advertising content further comprises displaying advertising content for the identified related products.

18. The computer program product of claim 13 wherein:
each digital reference image represents a consumer product, each digital reference image is associated with an identifier of the consumer product represented by the digital reference image, and each digital reference image is also associated with one or more identifiers of related products;
identifying consumer products within camera range further comprises identifying, from the digital reference images, one or more related products for each identified consumer product; and
displaying advertising content further comprises displaying advertising content for the identified related products that are not within camera range.
